(19) United States
(12) Patent Application Publication
(10) Pub. No.: US 2012/0268374 A1
(43) Pub. Date: Oct. 25, 2012

(54) METHOD AND APPARATUS FOR PROCESSING TOUCHLESS CONTROL COMMANDS

(76) Inventor: Arthur D. Heald, Plano, TX (US)

(21) Appl. No.: 13/456,184

(22) Filed: Apr. 25, 2012

Related U.S. Application Data
(60) Provisional application No. 61/478,841, filed on Apr. 25, 2011.

(51) Int. Cl. G06F 3/033

(52) U.S. Cl. 345/158

(57) ABSTRACT

A method and apparatus of detecting an input gesture command are disclosed. According to one example method of operation, a digital image may be obtained from a digital camera of a pre-defined controlled movement area. The method may also include comparing the digital image to a pre-stored background image previously obtained from the digital camera of the same pre-defined controlled movement area. The method may also include identifying one or more pixel differences between the digital image and the pre-stored background image and designating the digital image as having a detected input gesture command.

### CROSS-REFERENCE TO RELATED APPLICATIONS

This application claims priority to U.S. provisional patent application Ser. No. 61/478,841 entitled TOUCHLESS CONTROL, filed Apr. 25, 2011, the entire contents of which are herein incorporated by reference.

### TECHNICAL FIELD OF THE INVENTION

This disclosure relates to touchless user input commands being identified and processed to perform tasks and related functions.

### BACKGROUND OF THE INVENTION

Conventionally, electronic and computer-based devices may be operated via remote controls. However, those separate devices are expensive and lose battery power or become lost over time. One way to overcome remote controls is to include a motion detector, camera or other type of interface designed to receive touchless commands via an input interface. Certain devices and related processing algorithms that support touchless commands are limited in their capabilities to identify user hand gestures. For example, the known touchless user input technology has a limited capability to identify a hand, finger and/or palm movement and distinguish such a hand movement over other types of hand movements. This limited identification functionality of conventional interfaces has, in turn, offered limited growth in the types of applications that can be integrated with hand or user input gesture commands in general.

### SUMMARY OF THE INVENTION

One embodiment of the present invention may include a method of detecting an input gesture command. The method may include obtaining at least one digital image from a digital camera of a pre-defined controlled movement area comparing, via a processor, the at least one digital image to at least one pre-stored background image previously obtained from the digital camera of the same pre-defined controlled movement area and identifying, via the processor, at least one pixel difference between the at least one digital image and the at least one pre-stored background image. The method may also include designating, via the processor, the at least one digital image as having a detected input gesture command.

Another example embodiment of the present invention may include an apparatus configured to detect an input gesture command including a digital camera and a receiver configured to receive at least one digital image from the digital camera of a pre-defined controlled movement area. The apparatus may also include a processor configured to compare the at least one digital image to at least one pre-stored background image previously obtained from the digital camera of the same pre-defined controlled movement area, identify at least one pixel difference between the at least one digital image and the at least one pre-stored background image, and designate the at least one digital image as having a detected input gesture command.

### BRIEF DESCRIPTION OF THE DRAWINGS

FIG. 1 illustrates an example motion detection configuration according to example embodiments.

FIG. 2A illustrates an example pixel comparison logic operation according to example embodiments.

FIG. 2B illustrates an example pixel comparison logic operation based on a detected hand movement according to example embodiments.

FIG. 2C illustrates an example grid point hand movement reconstruction operation according to example embodiments.

FIG. 3 illustrates an example logic diagram of a motion detection system according to example embodiments.

FIG. 4 illustrates an example image processing system configuration according to example embodiments.

FIG. 5 illustrates a network entity that may include memory, software code and other computer processing hardware used to perform various operations according to example embodiments.

FIG. 6 illustrates a flow diagram of an example method of operation according to example embodiments.

### DETAILED DESCRIPTION OF THE INVENTION

It will be readily understood that the components of the present invention, as generally described and illustrated in the figures herein, may be arranged and designed in a wide variety of different configurations. Thus, the following detailed description of the embodiments of a method, apparatus, and system, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present invention, the invention may be applied to many types of network data, such as packet, frame, datagram, etc. For purposes of this invention, the term “message” also includes packet, frame, datagram, and any equivalents thereof. Furthermore, while certain types of messages and signaling are depicted in exemplary embodiments of the invention, the invention is not limited to a certain type of message, and the invention is not limited to a certain type of signaling.

Example embodiments of the present invention provide touchless control communication devices, algorithms and computer-based operations. Examples of touchless input commands may include a user providing input commands by hand gestures, arm gestures, finger movements, fist movements, wrist movements, arm movements and a combination thereof. The commands may be detected by a standalone device that is configured to detect the user input via infrared feedback signals. The user may perform the hand movements to enact a conference room control function (i.e., begin presentation, turn presentation slide, lower screen, dim lights, etc.). Other uses for the touchless input commands may include residential household controls, gaming, etc.

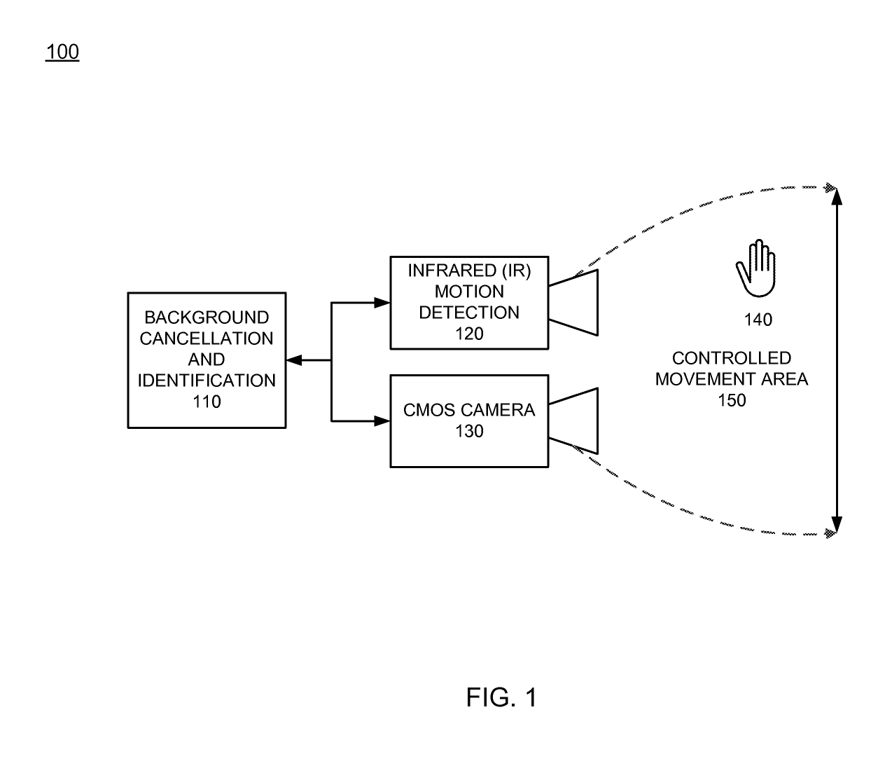

FIG. 1 illustrates an example touchless signal detection and related processing device 100, according to example embodiments. Referring to FIG. 1, a background cancellation and identification module 110 may receive information provided by a complementary symmetry metal oxide semiconductor (CMOS) camera and/or the infrared (IR) motion detector 120, which together may identify a hand gesture movement 140 with a given controlled movement area 150. The device itself may be a black box device with all of the aforementioned components and may be configured with an Ethernet interface and/or RS-48S data interface and/or a wireless network interface (Bluetooth, 802.xx, etc.) to communicate with other remote communication devices.

The device 100 may also include a 12 volt power source and IR sensor to detect a movement in the proximity of the controlled movement area 150. The IR sensor 120 may alert the CMOS camera 130 to begin recording and to digitally capture various frames that are believed to include new hand gesture input commands. An audio feedback unit (not shown) may alert the user of the identified commands to allow the user to confirm or deny the command. Such a device would be configured to identify hand commands, such as (i.e., finger movements), right, left, up, down, towards, away and other movements. The response time of the device may also be around 200 ms.

Referring again to FIG. 1, a digital image may be captured by the CMOS camera 130 of the CMA 150 before any hand movements are present. Such an image may be deemed a background or control image or frame, and may be used to compare subsequently captured frames to determine if hand gestures are being performed. The background image or frame may be multiple images used to ensure the background is still and free from any motion changes or user input. The background frame may be logically compared to the recently obtained digital image(s) or frame via an exclusive OR operation (XOR). This process of XOR-ing the pixels of the background frame to the recently obtained digital frame yields various content differences between the two frames and provides a resulting content of pixels that were effected by the user input gesture (i.e., hand movement).

The background frame may be normalized to have all zero value pixels which are compared to the corresponding location pixels of the recently obtained digital (new) frame and the differences in the new frame will be identified as non-zero values. In practice, the sum of the two frames must meet or exceed a predetermined threshold difference value in order to be deemed a gesture inclusive frame. If the camera position were to change, an automated re-calibration procedure would need to be conducted to identify the background of the new camera position. The camera 130 may perform automatic and periodic calibration efforts by obtaining snapshots and using them as a new basis for a background frame based on a digital image. A frame may be considered a message or data packet of digital data based on a still frame(s) of content from a digital camera snapshot.

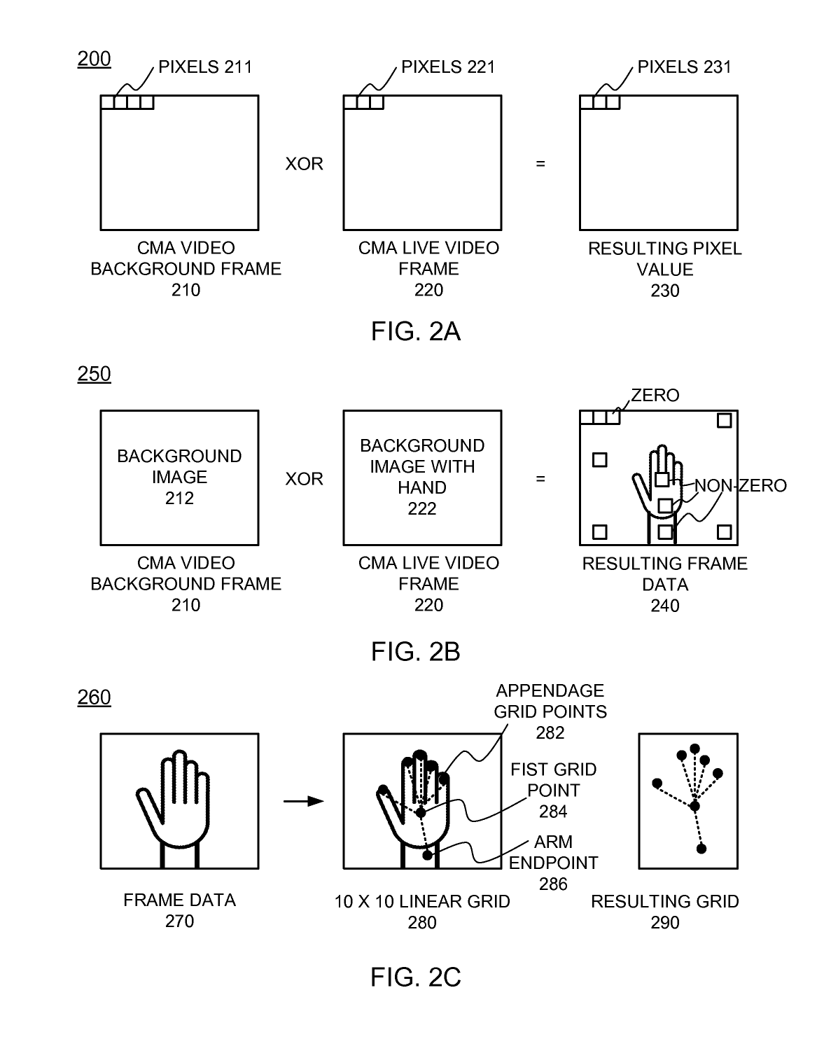

FIG. 2A illustrates an example of a pixel comparison operation 200 according to example embodiments. Referring to FIG. 2A, the CMA video background frame 210 may include various “0” value pixels. The background frame 210 may be obtained when the IR sensor detects motion in the CMA. This motion may trigger a new recalibration procedure. For example, if there is no movement in the CMA for a given time period and the XOR results are above a given threshold then a recalibration procedure may occur. In FIG. 2A, the pixels of the background frame and the new frame are XOR-ed and the results in this case would be only based on non-zero pixel results of one frame being compared to zero results of another frame which would yield a pixel difference between the frames. The XOR of the summed pixels will equal zero if there are no changes in the CMA. The background frame will provide a basis for movement and shape identification to proceed.

FIG. 2B illustrates an example of a movement and shape identification block 250. Referring to FIG. 2B, a video background frame 210 includes a corresponding background image 212. The content of the background frame may be XOR-ed with the background image 222 of a live video frame (new frame) 220. The resulting frame 240 would ideally yield only the user's hand or gesture movement data. All zero pixels from the XOR operation would be removed and the differences would be readily identified as the user's hand movement absent the background image data. As change occurs in the CMA and it is captured by the digital camera, the changes will result in non-zero values after the XOR operation. The resulting frame data may now be associated with a linear representation of the obtained image data to minimize the amount of processor use required for determining the user's input command gesture.

FIG. 2C illustrates the shape conversion and linear representation 260 processing in further detail. Referring to FIG. 2C, the frame data 270 may be isolated and removed from the background data and converted to a linear grid 280. The grid may be used to identify grid points which correspond to the user's hand or arm. Once the data is formatted to a linear grid, the hand identification procedure may include pairing points with a center portion of the object and using that center point as a basis for identifying the appendages (i.e., fingers) and the arm portion (i.e., lower point). Once the arm is identified, the appendage positions 282, 284 and 286 may be identified to determine if the user is indicating a particular signal, such as a number “1” (i.e., first appendage is extended and the others are part of the first area identified). Subsequent images may be used to identify a particular type of motion, such as waiving right, left, up or down. The identified linear representation 290 may be compared to previously stored linear representations to offer a comparison template and determination procedure (i.e., hand position for a “1”, etc.).

The linear representation may include formatting the hand image to a linear grid. The hand identification may also include identifying one point as the center of the hand (i.e., fist) which is marked on the grid. The upper points above the fist may be identified as the appendages and the lower points as the arm. The points are connected to form a linear representation around a centered fist. The linear representation may be the basis for comparison purposes to known or pre-stored user command gestures.

Once a linear representation is obtained, a series of IF-THEN logic commands may be used to identify the specific command intended by the user. For example, if the arm endpoint is located at gridpoint (x, y) and the center of the fist is at gridpoint (a, b) and one appendage is identified as being above the others by an appreciable distance, then the logic may indicate a “1” as the resulting command. Instead, if there were two appendages identified, the command may be “2”, and if there are no appendages identified, the command may be “0”. To avoid false commands the “0” should be used as an enter function. For example, if the number “5” turned a conference room projector to the “ON” state, then a command of “5” followed by a “0” may be used to indicate an enter function. If the command is accepted an audible indicator may be used to confirm the input.

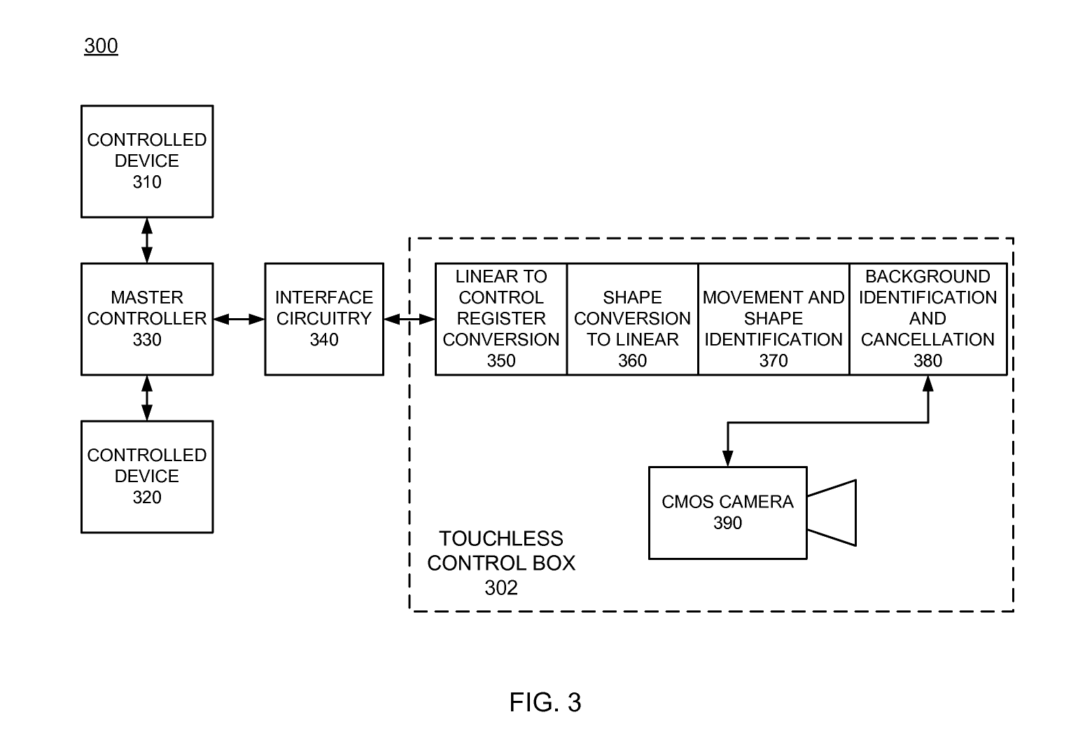

FIG. 3 illustrates an example logic diagram of a motion detection system 300 according to example embodiments. Referring to FIG. 3, a master controller 330 may be used to control devices 320 as peripheral or remote devices. The interface circuitry 340 may be used as an interface to the controller of a controlling device, such as a computer or server, etc. The touchless control box may be a black box device manufactured as an input interface used to capture user movement and process the information and transmit commands accordingly. Alternatively, the processing may be performed by a corresponding computer coupled to the control box 302 via a data interface.

The control box 302 may include a CMOS camera 390 that is configured to capture images and provide background frames to a background identification and cancellation module 380. The movements captured in subsequent frames may be identified via a movement and shape identification module 370. The shapes may be converted to linear representations via the conversion module 360 and submitted to a linear control and register conversion module 350. The data images may be obtained and compared to pre-stored image data in a database (not shown) as a basis to determine what type of commands are being received. The master controller 330 may receive a command to transfer a command to a remote controlled device 310/320 based on the identified user input gesture command.

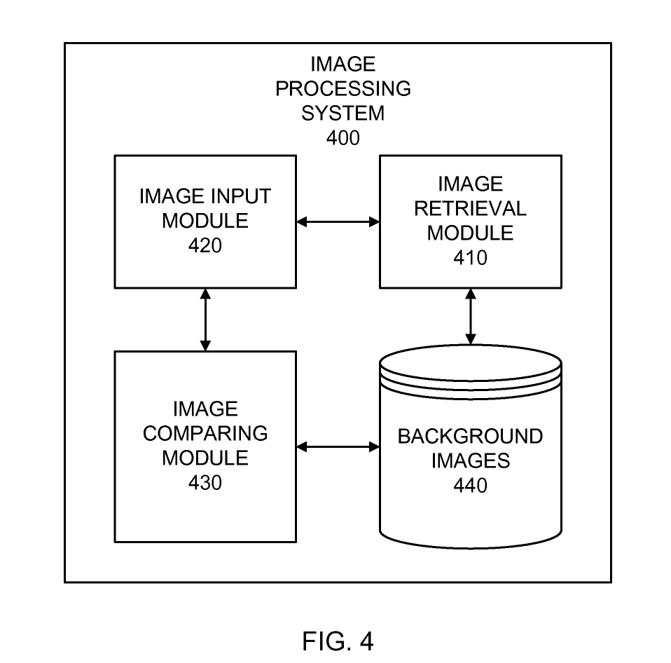

FIG. 4 illustrates an example image processing system 400 configuration according to example embodiments. Referring to FIG. 4, detecting an input gesture command may be performed by obtaining at least one digital image from a digital camera of a pre-defined controlled movement area (CMA). The at least one digital image may be compared to at least one pre-stored background image previously obtained from the digital camera of the same pre-defined controlled movement area. The background images may be stored in a background image database 440. The image retrieval module 410 may retrieve the background image(s) and use it as a basis for the comparison operation. The image input module 420 may receive the new images obtained by the digital camera and compare those images to the retrieved images. At least one pixel difference between the at least one digital image and the at least one pre-stored background image may be observed by the image comparing module 430. The at least one digital image may then be designated as having a detected input gesture command included in its image data content.

The digital camera may be triggered to obtain the at least one digital image based on a movement detected by an infrared (IR) sensor coupled to the processor associated with the digital camera. The at least one digital image content may be converted to a linear representation to identify a type of input gesture command provided by the user. The linear representation may include a plurality of gridpoints used to identify the user's body part used for the input gesture command. The linear representations may be compared to a pre-stored linear representation to identify the type of input gesture command. Once the command is identified, the command may be transmitted to a remote device based on the identified type of input gesture command.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

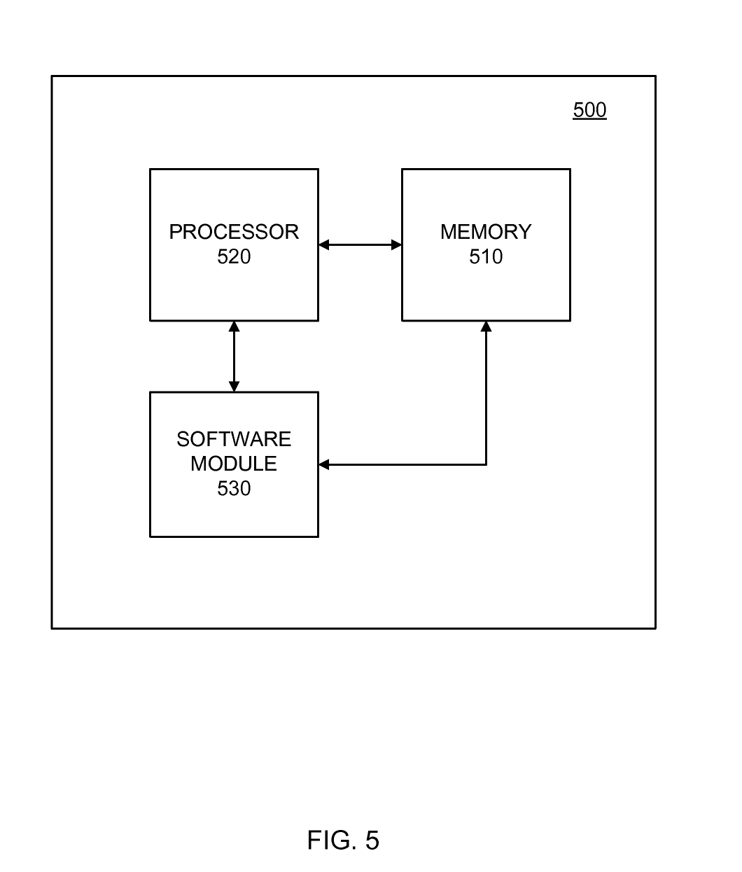

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 5 illustrates an example network element 500, which may represent any of the above-described network components of the other figures.

As illustrated in FIG. 5, a memory 510 and a processor 520 may be discrete components of the network entity 500 that are used to execute an application or set of operations. The application may be coded in software in a computer language understood by the processor 520, and stored in a computer readable medium, such as, the memory 510. Furthermore, a software module 530 may be another discrete entity that is part of the network entity 500, and which contains software instructions that may be executed by the processor 520. In addition to the above noted components of the network entity 500, the network entity 500 may also have a transmitter and receiver pair configured to receive and transmit communication signals (not shown).

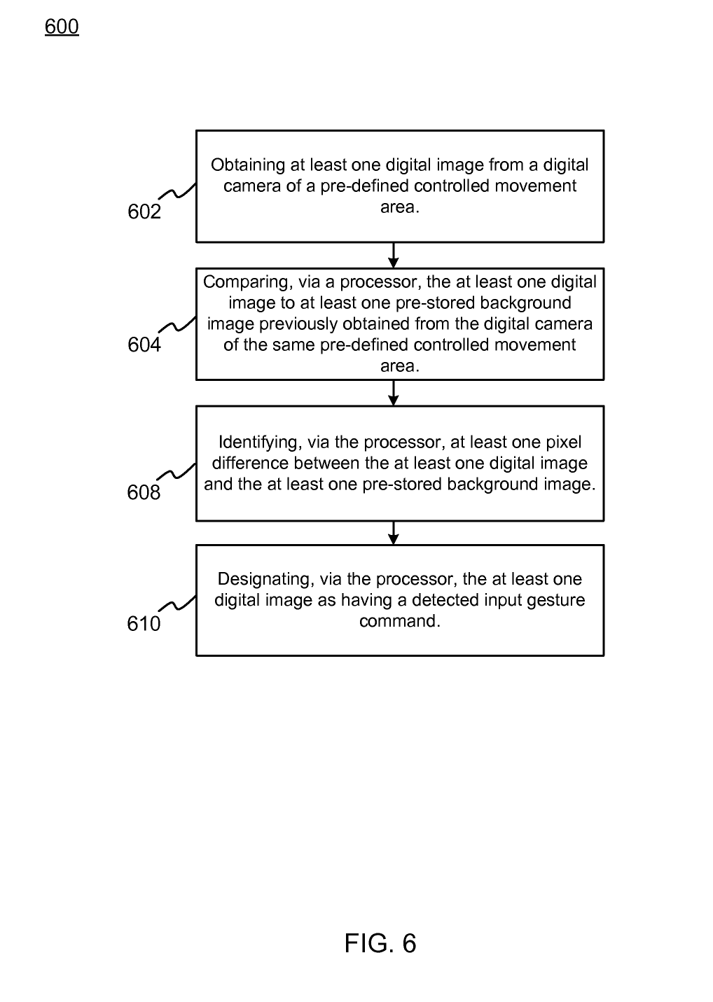

One example method of operation is illustrated in the flow diagram of FIG. 6. Referring to FIG. 6, a method of detecting an input gesture command is disclosed. The method may include obtaining at least one digital image from a digital camera of a pre-defined controlled movement area at operation 602. The method may also include comparing, via a processor, the at least one digital image to at least one pre-stored background image previously obtained from the digital camera of the same pre-defined controlled movement area at operation 604. The method may also include identifying, via the processor, at least one pixel difference between the at least one digital image and the at least one pre-stored background image, at operation 606. The method may also include designating, via the processor, the at least one digital image as having a detected input gesture command, at operation 608.

Although an exemplary embodiment of the system, method, and non-transitory computer readable medium of the present application has been illustrated in the accompanied drawings and described in the foregoing detailed description, it will be understood that the present invention is not limited to the embodiments disclosed, but is capable of numerous rearrangements, modifications, and substitutions without departing from the spirit or scope of the invention as set forth and defined by the following claims. For example, the capabilities of the systems illustrated in FIGS. 1, 3 and 4 may be performed by one or more of the modules or components described herein or in a distributed architecture. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

While preferred embodiments of the present invention have been described, it is to be understood that the embodiments described are illustrative only and the scope of the invention is to be defined solely by the appended claims when considered with a full range of equivalents and modifications (e.g., protocols, hardware devices, software platforms etc.) thereto.

What is claimed is:

1. A method of detecting an input gesture command comprising:
obtaining at least one digital image from a digital camera of a pre-defined controlled movement area;
comparing, via a processor, the at least one digital image to at least one pre-stored background image previously obtained from the digital camera of the same pre-defined controlled movement area;
identifying, via the processor, at least one pixel difference between the at least one digital image and the at least one pre-stored background image; and
designating, via the processor, the at least one digital image as having a detected input gesture command.

2. The method of claim 1, further comprising:
triggering the digital camera to begin obtaining the at least one digital image based on a movement detected by an infrared (IR) sensor coupled to the processor associated with the digital camera.

3. The method of claim 1, further comprising:
converting content of the at least one digital image to a linear representation to identify a type of input gesture command.

4. The method of claim 3, wherein the linear representation comprises a plurality of gridpoints used to identify the user's body part used for the input gesture command.

5. The method of claim 4, further comprising:
comparing the linear representation to a pre-stored linear representation to identify the type of input gesture command; and
identifying the type of input gesture command.

6. The method of claim 5, further comprising:
transmitting a command to a remote device based on the identified type of input gesture command.

7. The method of claim 1, wherein the digital camera is a complementary symmetry metal oxide semiconductor (CMOS) camera.

8. An apparatus configured to detect an input gesture command comprising:
a digital camera;
a receiver configured to receive at least one digital image from the digital camera of a pre-defined controlled movement area; and
a processor configured to
compare the at least one digital image to at least one pre-stored background image previously obtained from the digital camera of the same pre-defined controlled movement area,
identify at least one pixel difference between the at least one digital image and the at least one pre-stored background image, and
designate the at least one digital image as having a detected input gesture command.

9. The apparatus of claim 8 wherein the processor is further configured to trigger the digital camera to begin obtaining the at least one digital image based on a movement detected by an infrared (IR) sensor coupled to the processor associated with the digital camera.

10. The apparatus of claim 8, wherein the processor is further configured to convert content of the at least one digital image to a linear representation to identify a type of input gesture command.

11. The apparatus of claim 10, wherein the linear representation comprises a plurality of gridpoints used to identify the user's body part used for the input gesture command.

12. The apparatus of claim 11, wherein the processor is further configured to compare the linear representation to a pre-stored linear representation to identify the type of input gesture command and identify the type of input gesture command.

13. The apparatus of claim 12, further comprising:
a transmitter configured to transmit a command to a remote device based on the identified type of input gesture command.

14. The apparatus of claim 1, wherein the digital camera is a complementary symmetry metal oxide semiconductor (CMOS) camera.

15. A non-transitory computer readable storage medium configured to store instructions that when executed cause a processor to detect an input gesture command, the processor being further configured to perform:
obtaining at least one digital image from a digital camera of a pre-defined controlled movement area;
comparing, via a processor, the at least one digital image to at least one pre-stored background image previously obtained from the digital camera of the same pre-defined controlled movement area;
identifying, via the processor, at least one pixel difference between the at least one digital image and the at least one pre-stored background image; and
designating, via the processor, the at least one digital image as having a detected input gesture command.

16. The non-transitory computer readable storage medium of claim 15, wherein the processor is further configured to perform:
triggering the digital camera to begin obtaining the at least one digital image based on a movement detected by an infrared (IR) sensor coupled to the processor associated with the digital camera.

17. The non-transitory computer readable storage medium of claim 15, wherein the processor is further configured to perform:
converting content of the at least one digital image to a linear representation to identify a type of input gesture command.

18. The non-transitory computer readable storage medium of claim 17, wherein the linear representation comprises a plurality of gridpoints used to identify the user's body part used for the input gesture command.

19. The non-transitory computer readable storage medium of claim 18, wherein the processor is further configured to perform:
comparing the linear representation to a pre-stored linear representation to identify the type of input gesture command; and
identifying the type of input gesture command.

20. The non-transitory computer readable storage medium of claim 15, wherein the processor is further configured to perform:
transmitting a command to a remote device based on the identified type of input gesture command.
